(19) United States
(12) Patent Application Publication
(10) Pub. No.: US 2014/0115176 A1
(43) Pub. Date: Apr. 24, 2014

(54) CLUSTERED SESSION MANAGEMENT

(71) Applicant: Cassidian Communications, Inc., Temecula, CA (US)

(72) Inventors: Ameel Kamboh, Murrieta, CA (US); Jason Wellonen, Temecula, CA (US); James Stelzig, Gatineau (CA)

(73) Assignee: Cassidian Communications, Inc., Temecula, CA (US)

(21) Appl. No.: 14/058,049

(22) Filed: Oct. 18, 2013

Related U.S. Application Data
(60) Provisional application No. 61/717,062, filed on Oct. 22, 2012.

(51) Int. Cl. H04L 29/08

(52) U.S. Cl. CPC H04L 67/142
USPC 709/228

(57) ABSTRACT

Systems and methods for emergency call-center session routing in an all-active cluster formation are provided. Each node in a cluster receives sessions through load balanced distribution. Nodes in the cluster may be configured to use a common database. The database is synchronized across the cluster ensuring that data is accessible by any node in the cluster. Session state is maintained in the database, such that any session can be managed by any node in the cluster.

### CROSS-REFERENCE TO RELATED APPLICATIONS

This application claims priority benefit under 35 U.S.C. §119(e) to U.S. Provisional Application No. 61/717,062, filed on Oct. 22, 2012, entitled “Clustered Session Management,” the disclosure of which is hereby incorporated herein by reference in its entirety. Any and all priority claims identified in the Application Data Sheet, or any correction thereto, are hereby incorporated by reference under 37 C.F.R. §1.57.

This application is related to U.S. application Ser. No. 13/526,305 filed on Jun. 18, 2012 and published as U.S. Publication No. 2012/0320912 on Dec. 20, 2012, entitled “Systems, Apparatus, and Methods for Collaborative and Distributed Emergency Multimedia Data Management,” the disclosure of which is hereby incorporated herein by reference in its entirety.

### BACKGROUND

1. Field

The present development relates to clustered session management.

2. Description of Related Art

The development may find use in connection with various types of communication sessions. A session generally refers to a communication between a source device and a destination via a network. A telephone call may be a session. A chat via instant messenger may be a session. A video stream may be a session. The session may be created with the network such as via a session initiation protocol. The session initiation protocol may provide packet based access and routing of the session data.

Failover may be provided in systems servicing the sessions. For example, a public safety answering point (PSAP) may be configured to receive multimedia emergency sessions. These sessions are routed to an appropriate agent to respond to the emergency. Failover is generally provided in the form of an active system and a standby system. The active system receives the incoming session and distributes the session to the appropriate agent. The distribution may be random, sequential, or according to a selection algorithm. The standby system is generally configured similarly to the active system, but it stands idle until the active system experiences a failure. In such case, the standby system becomes the active system and begins handling subsequent sessions.

One shortcoming of the failover system described above is the loss of information for active sessions such as when there is a system failure. Once the active system fails, the sessions which were being processed by the now-disabled system may be lost.

Another technique included in session servicing systems to enhance availability of the system is the use of a series of session distribution servers. In some implementations, this may be referred to as a “farm of servers”. One session distribution server in the farm is selected to receive an incoming session via a load balancing server. The load balancing server may select a distribution server based on the load for each distribution server, the number of active sessions for each distribution server, random, sequential, or other load balancing techniques which are known to one of skill in the art.

One shortcoming of the farm of servers approach is that each session distribution server is unaware of what the other session distribution servers are doing. In this approach, a first session may be received at a first session distribution server for routing to a first agent. A second session may be received at a second session distribution server that is not in communication with the first session distribution server, and the first agent may again be selected for servicing the session. In this way, the distribution of the sessions may not be performed based on all available information within the system, but rather the information locally available to a node. Furthermore, recipients would each need to register with each node in the farm of servers to be eligible for distribution of a session. The farm of servers also suffers from the above discussed issue of losing session data in the event a session distribution server is disrupted.

Accordingly, improved systems and methods for clustered session management are desirable.

### SUMMARY

The systems, methods, and devices of the disclosure each have several innovative aspects, no single one of which is solely responsible for the desirable attributes disclosed herein.

In one innovative aspect, a system is provided. The system includes a first node and a second node. The first node and the second node are configured to receive and maintain communication session information. The first node and the second node are executed on at least one session management server. The system includes a distributed database. The first node and the second node include an instance of the distributed database. The distributed database is configured to store at least one characteristic of the first node and at least one characteristic of the second node. The system further includes a session load balancing server. The session load balancing server is configured to receive a communication session. The session load balancing server is further configured to identify one of the first node or the second node to receive the communication session based at least in part on a policy and the at least one characteristic for the first node and the at least one characteristic of the second node. The session load balancing server is also configured to produce an indicator indicative of the communication session and the identified node, wherein the identified node is configured to obtain the communication session from the distributed database.

In some implementations of the system, the communication session information includes a session state, a session identifier, and a current node. The characteristic of the first node and the second node may include one or more of a number of answering points coupled to the node, a number of communication sessions handled over a unit of time, a node load, or a node session volume.

A cluster management server configured to monitor the first node and the second node may be included in some implementations of the system. Upon failure of one of the first node or the second node, the cluster management server may be configured to update one or more communication session information entries in the distributed database associated with the failed node, the entries to be associated with an active node, the active node configured to reconstruct the communication session based at least in part on the communication session information. The update may be based on at least in part on the policy and the at least one characteristic of the active node. The cluster management server may be configured to generate a re-invite message based on the communication session information and transmit the re-invite message to the active node. In some implementations, the cluster management server may be configured to receive a registration request from a third node, the registration request including a node configuration and a node state and store the registration request in the distributed database. In such implementations, the session load balancer may be configured to identify one of the first node, the second node, or the third node to receive the communication session.

The communication session may be or include a session initiation protocol communication session. In some implementations, the first node is associated with a first answering point and the second node is associated with a second answering point. It may be desirable, in some implementations, for the policy to include a threshold value for a node characteristic, wherein a node may be identified based on a comparison of a value for the characteristic of the node with the threshold value.

In another innovative aspect, a method of managing communication sessions is provided. The method includes registering a first node and a second node. The method includes obtaining at least one characteristic of the first node and at least one characteristic of the second node. The method further includes receiving a communication session. The method also includes identifying one of the first node or the second node to receive the communication session based at least in part on a policy and the at least one characteristic of the first node and the at least one characteristic of the second node. The method also includes providing communication session information to the identified node.

In some implementations, the communication session information includes a session state, a session identifier, and a current node.

In some implementations, the characteristic of the first node and the second node includes one or more of a number of answering points coupled to the node, a number of communication sessions handled over a unit of time, a node load, or a node session volume.

In some implementations, the method further includes upon failure of one of the first node or the second node, updating one or more communication session information entries in the distributed database associated with the failed node, the entries to be associated with an active node, the active node configured to reconstruct the communication session based at least in part on the communication session information. In such implementations, the updating may be based on at least in part on the policy and the at least one characteristic of the active node. In some instances, the method includes generating a re-invite message based on the communication session information and transmitting the re-invite message to the active node. In some implementations, the method includes receiving a registration request from a third node, the registration request including a node configuration and a node state and storing the registration request in the distributed database, wherein identifying a node may include identifying one of the first node, the second node, or the third node to receive the communication session.

In some implementations, the communication session may include a session initiation protocol communication session. In some implementations of the method, the first node may be associated with a first answering point and the second node may be associated with a second answering point.

In a further innovative aspect, a computer readable storage medium comprising instructions is provided. The instructions, upon execution by a processor of a device, cause the device to register a first node and a second node. The instructions further cause the device to obtain at least one characteristic of the first node and at least one characteristic of the second node. The instructions also cause the device to receive a communication session. The instructions further cause the device to identify one of the first node or the second node to receive the communication session based at least in part on a policy and the at least one characteristic for the first node and the at least one characteristic of the second node; The instructions also cause the device to provide communication session information to the identified node.

In yet another innovative aspect, another system is provided. The system includes means for receiving and maintaining communication session information. The system includes means for distributed storage of at least one characteristic of the means for receiving and maintaining communication session information. The system includes means for session load balancing. The means for session load balancing is configured to receive a communication session. The means for session load balancing is further configured to identify said means for receiving and maintaining communication session information to receive the communication session based at least in part on a policy and the at least one characteristic. The means for session load balancing is further configured to produce an indicator indicative of the communication session and the identified means for receiving and maintaining communication session information, wherein the identified means for receiving and maintaining communication session information is configured to obtain the communication session from said means for distributed storage.

### BRIEF DESCRIPTION OF THE DRAWINGS

FIG. 1 shows a functional block diagram of a communication system.

FIG. 2 shows a functional block diagram of an automated session distributer.

FIG. 3 shows a functional block diagram of a node that may be included in an automated session distribution system.

FIG. 4 shows a functional block diagram of an example cluster.

FIG. 5 shows a functional block diagram of another example cluster.

FIG. 6 shows a process flow diagram of an example method of managing communication sessions.

### DETAILED DESCRIPTION

Systems and methods for emergency call-center session routing in an all-active cluster formation are provided. Each node in a cluster receives sessions through load balanced distribution. All nodes in the cluster may be configured to use a common database. The database is synchronized across the cluster ensuring that data is accessible by any node in the cluster. Session state is maintained in the database, such that any session can be managed by any node in the cluster.

The systems and methods described each have several aspects, no single one of which is solely responsible for its desirable attributes. Without limiting the scope of this disclosure, some features will now be discussed briefly. After considering this discussion, and particularly after reading the section entitled “Detailed Description” one will understand how the features described provide advantages that include providing clustered session management.

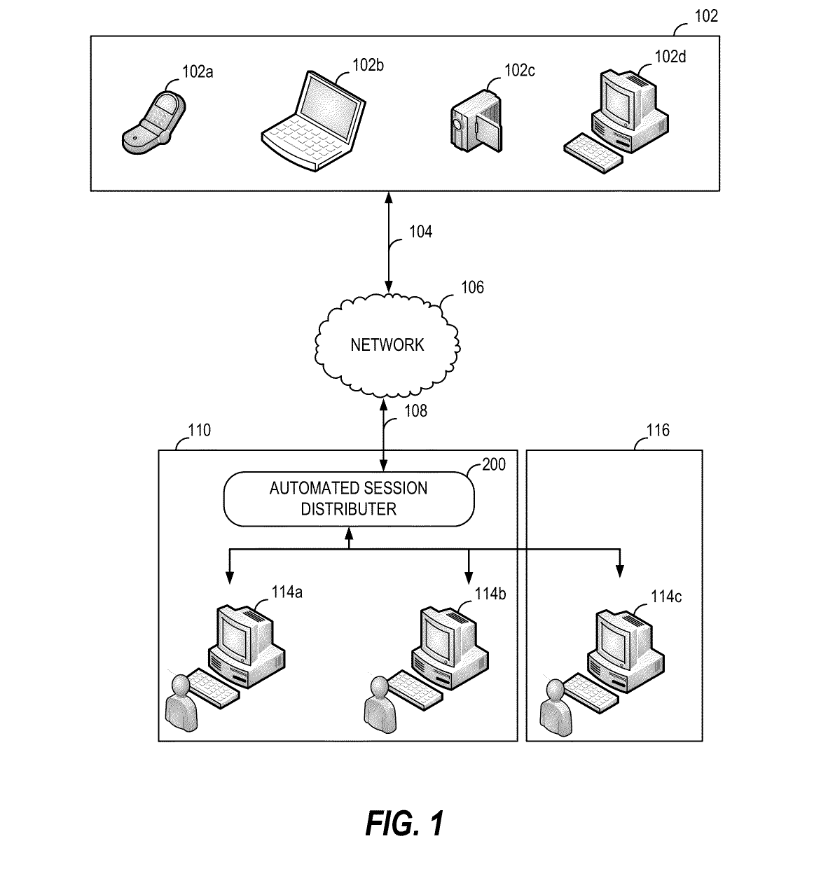

FIG. 1 shows a functional block diagram of a communication system. The communication system may include one or more source devices. As shown in FIG. 1, the source devices may include, but are not limited to, a mobile phone 102a, a laptop computer 102b, a camera 102c, and a desktop computer 102d (collectively and individually referred to hereinafter as “source device 102”). The source device 102 generally includes a communication interface allowing the source device 102 to communicate via an input communication link 104 with a network 106.

The input communication link 104 may be a wired link such as an Ethernet, fiber optic, or a combination thereof. The input communication link 104 may be a wireless link such as a cellular, satellite, near field communication, or Bluetooth link. In some implementations, the input communication link 104 may include a combination of wired and wireless links.

The network 106 may be a public or private network. The network 106 may include voice over IP (VoIP) networks, enterprise networks, cellular networks, satellite networks, or public switched telephone network (PSTN). The network 106 may be a collection of networks in data communication such as a cellular network including a packet gateway to an IP-based network.

The network 106 may be configured to communicate via an answering point communication link 108 with an answering point 110. For example, the answering point 110 may be a public safety answering point (PSAP) for emergency sessions (e.g., calls). While references may be included to emergency session management, emergency sessions are used as an example of the types of sessions that may be automatically distributed in a clustered configuration consistent with the described systems and methods. Customer service sessions, sales sessions, or other communication sessions may be clustered with the described systems and methods.

The answering point communication link 108 may be a wired link such as an Ethernet, fiber optic, or a combination thereof. The answering point communication link 108 may be a wireless link such as a cellular, satellite, near field communication, or Bluetooth link. In some implementations, the answering point communication link 108 may include a combination of wired and wireless links.

The answering point 110 is configured to receive the session and route the session to an appropriate agent to handle the session. For example, if the session is an emergency service phone call, the call may be routed to an agent to obtain additional details about the emergency and/or to dispatch emergency units. To route the session, the answering point 110 may include an automated session distributer 200.

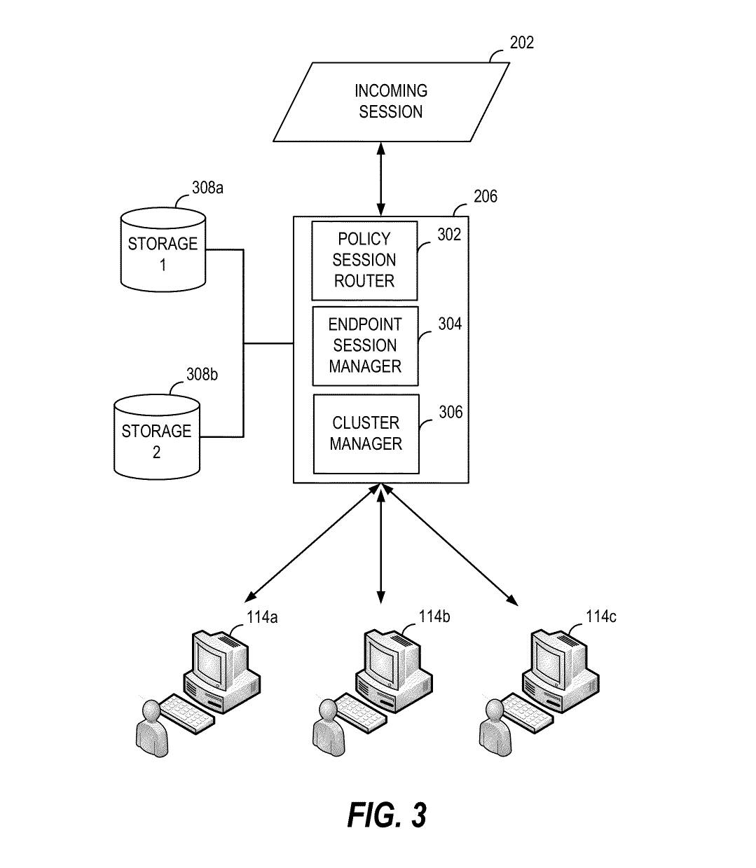

The automated session distributer 200 is configured to receive incoming sessions and identify the appropriate agent to handle the incoming session. An exemplary system for associating sessions with the appropriate agent(s) is shown and described in commonly owned U.S. patent application Ser. No. 13/526,305 filed on Jun. 18, 2012 which was also included as Appendix A of the provisional application from which this application claims priority. The disclosure of U.S. patent application Ser. No. 13/526,305 is hereby incorporated in its entirety by reference. For example, FIG. 3 of U.S. patent application Ser. No. 13/0526,305 shows a policy engine and an event distribution module which are configured to associate sessions with one or more agents.

The automated session distributer 200 will be described in further detail below. The answering point 110 may include one or more answering endpoints. As shown in FIG. 1, the answering point 110 includes a first answering endpoint 114a and a second answering endpoint 114b. The automated session distributer 200 may be configured to distribute sessions to the first answering endpoint 114 or the second answering endpoint 114b. In some implementations, the communication system may include a remote answering point 116. The remote nature of the remote answering point 116 generally refers to the configuration wherein the remote answering point 116 is not co-located with the automated call distributer 200. For example, in a packet based communication system, a session may be transferred via a packet network to a remote answering endpoint 114c in data communication with the packet network. The remote answering endpoint 114c may be physically located at a site which is different than the automated session distributer 200, such as at a secondary answering point. For ease of discussion, the first answering endpoint 114a, the second answering endpoint 114b, and the remote answering endpoint 114c may collectively or individually be referred to hereinafter as “answering endpoint 114.”

The answering endpoint 114 may be configured to display information about the session such as information identifying the source device 102 or a registered user of the source device 102. The answering endpoint 114 may be configured for bi-directional communication with the automated session distributer 200. For example, if the first answering endpoint 114a receives a session that the agent cannot handle, the session may be sent back to the automated session distributer 200 for re-routing to the second answering endpoint 114b or the remote answering endpoint 114c.

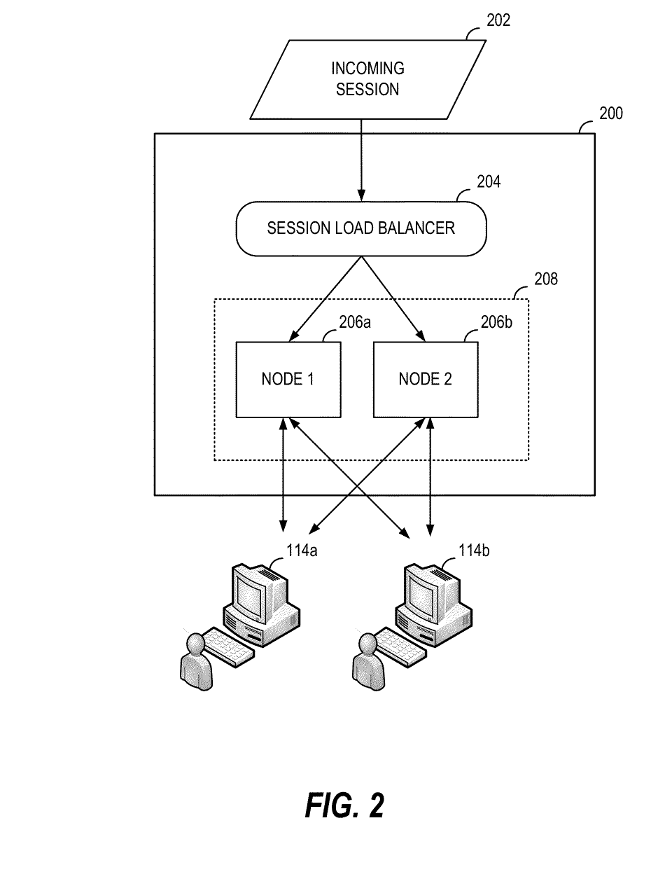

FIG. 2 shows a functional block diagram of an automated session distributer. As discussed above, the automated session distributer 200 is configured to receive an incoming session 202 and route the incoming session 202 to an answering endpoint 114. The automated session distributer 200 includes a session load balancer 204. In some implementations, the automated session distributed 200 may be configured to communicate with a session load balancer 204 rather than including the session load balancer. The session load balancer 204 is configured to balance the distribution of the sessions to nodes within the automated session distributer 200. The session load balancer 204 may distribute sessions based on a round robin scheme, a random scheme, feedback information from the nodes such as processing load, session load, memory, power, temperature, or other characteristic of the destinations (e.g., nodes) for the session, or a combination thereof.

As shown in FIG. 2, the automated session distributer 200 includes a cluster 208 including two nodes, a first node 206a and a second node 206b (collectively or individually referred to hereinafter as “node 206”). The cluster 208 generally describes a group of nodes 206 configured to process sessions for an automated session distributer 200. The node 206 generally describes a processor configured to manage sessions distributed thereto. The node 206 may be configured to identify the first answering endpoint 114a or the second answering endpoint 114b to process the incoming session 202. As shown in FIG. 2, each answering endpoint 114 may perform a single registration with the cluster 208 and receive sessions from the nodes included in the cluster 208, such as the first node 206a or the second node 206b in the implementation shown in FIG. 2. The answering endpoints may not be aware of the number of nodes included in the automated session distributer 200.

FIG. 3 shows a functional block diagram of a node that may be included in an automated session distribution system. FIG. 3 shows only one node 206 which may be included in, for example, the automated session distributer 200 shown in FIG. 2. The node 206 includes a policy session router 302. The policy session router 302 is configured to apply one or more policies for routing the incoming session 202 to an answering endpoint 114. For example, the policy may determine a number of sessions each answering endpoint 114 can handle in a period of time. Other policies may be implemented which are based on system characteristics such as overall session volume, relative session volume in relation to remote answering points. Other policies may be implemented which are based on characteristics of the incoming session 202. For example, an answering endpoint may not have video capability and, as such, may not be adequately configured to handle a video session. Combinations of the described policies may also be applied by the policy session router 302.

The policy session router 302 may be in data communication with one or more device for persisting data (e.g., memory or other non-transitory storage element). As shown in FIG. 3, a first storage device 308a and a second storage device 308b are in data communication with the node 206. In some implementations, additional storage elements may be provided. The first storage device 308a and the second storage device 308b are configured for replication of data stored therein. In one respect, this ensures that the failure of one storage device does not cause the entire system to fail. For ease of description, the first storage device 308a and the second storage 308b may be collectively or individually referred to as “storage 308.”

All nodes included in the cluster 208 are also configured to communicate with the first storage device 308a and the second storage device 308b. Accordingly, nodes may share data about sessions through the common storage 308. This provides a common basis for making routing decisions as the routing of the node 206 will also be considered during any routing determination at another node included in the same cluster 208.

The node 206 includes an endpoint session manager 304. The endpoint session manager 304 is configured to manage communications with the identified answering endpoint 114. For example, the endpoint session manager 304 provides session information to the answering endpoint 114 identified by the policy session router 302. As with the policy session router 302, the endpoint session manager 304 may be in data communication with the storage 308 shared amongst the nodes in the cluster 208.

The endpoint session manager 304 may also be configured to update the session information as additional data related to the session is received. The endpoint session manager 304 may also be configured to terminate a session when the session has been completed. For example, the endpoint session manager 304 may identify the end of a phone call session. Upon such identification, the endpoint session manager 304 may update a record in the storage 308 indicating the termination of the session.

Because the endpoint session manager 304 manages the session information using the shared storage, the endpoint session manager 304 of a first node may easily transfer a session to another node in the cluster by referencing a record in the storage 308. This may also provide a non-limiting advantage of allowing another node to continue managing the session should the initial node fail. For example, consider a chat session managed by a first node including a first endpoint session manager 304. Once the chat session is routed to an answering endpoint, the identified answering endpoint is associated with the session in the storage 308. If the first endpoint session manager 304 is disabled, a second endpoint session manager in another node may reconstruct the chat session and continue servicing the session based on the information in the storage 308.

In the event a node in the cluster fails, the cluster management (e.g., cluster manager 306) may select a node to take over sessions for the failed node. The newly elected node will then identify sessions for the failed node and recreate the session in the new node. This may be achieved by taking the state data from the storage of the existing session and transaction IDs that are stored, and re-invite the session to the newly elected node. In some implementations, this may include using SIP. The newly elected node will then recreate the session internally and update the storage with the node information. At this point, the session will be “transferred” to the new node. Since media is anchored on the media server and not the cluster itself, this failover scenario has no impact to media. The new node will resume responsibility for the media streams on the media server. Sessions which are in transit will time out on the failed node and upstream device will reinvite the session to another node selected by the load balancer.

The node 206 also includes a cluster manager 306. The cluster manager 306 is configured to provide configuration and/or state information for the node 206 as well as for the cluster 208 and other nodes included therein. For example, the configuration/state information for the node 206 or other nodes included in the cluster 208 may include number of answering endpoints associated with the node, identification of answering endpoints associated with the node, uptime for the node, load for the node, node processor state (e.g., active, idle, restart, malfunction), and the like. The configuration/state information for the cluster 208 may include the number of nodes in the cluster, the identity of the nodes in the cluster, cluster load, and the like. The cluster manager 306 may store this information via the storage 308 as well. In this way, each node may report its own state information and determine the state/configuration for itself, other nodes, and the cluster 208. A further non-limiting advantage of the described processes is the speed with which the reconstruction can occur. Because nodes in a cluster maintain session state information in a common storage, all or substantially all the information needed to reconstruct the session state is accessible by all nodes of the cluster. The cluster manager 306 associated with each node can negotiate which node will service the session(s) being handled by a failed node with a low level of service interruption. The negotiation may be based on the load of each node, first-in-first-out, random, or other routing policy in the event a node in the cluster becomes unavailable.

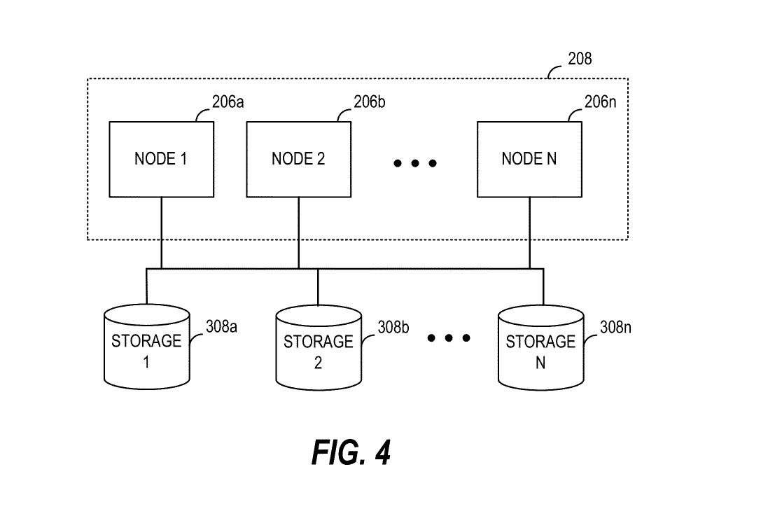

FIG. 4 shows a functional block diagram for a cluster. The cluster 208 shown includes the first node 206a and the second node 206b. The cluster 208 may include additional nodes. A node n 206n identifies the nth node of the cluster 208 where n is the number of nodes in the cluster 208. In some implementations, the cluster 208 may include, for example, 1 node, 10 nodes, 27 nodes, or 104 nodes. Each node is configured to manage multiple sessions. In one implementation, a node may be configured to manage 500 to 1000 sessions per second.

Each node of the cluster 208 is in data communication with one or more storage devices. As shown in FIG. 4, the cluster 208 is coupled with the first storage device 308a, the second storage device 308b, and an nth storage device 308n where n is the number of storage devices associated with the cluster. In some implementations, the cluster 208 may be associated with, for example, 2 storage devices, 6 storage devices, 30 storage devices, or 107 storage devices. The storage devices need not be physically co-located, but the storage devices should be configured for replication of data stored therein across the storage devices. In some implementations, it may be desirable to provide some of the storage devices at a separate physical facility in the event one answering facility is offline (e.g., a fire).

In some implementations, multiple clusters may be configured to use the same storage device(s). In some implementations, multiple clusters may be deployed at an answering point.

Having described several features, the example implementations that follow provide further illustrations of the features described alone or in conjunction with further innovative aspects.

In some implementations, routing applications may be deployed in an all-active cluster formation. Each node in the cluster may be configured to receive calls through load balanced distribution. Nodes in the cluster may be configured to use a common database which is synchronized across the cluster. The synchronization ensures that the data is accessible by any node in the cluster.

Call state can be maintained in the database, such that any call can be managed by any node in the cluster with connectivity to the database. This implementation provides support for node management, call management, and data management within the cluster. Additional systems/devices may be included to provide active-standby within the cluster.

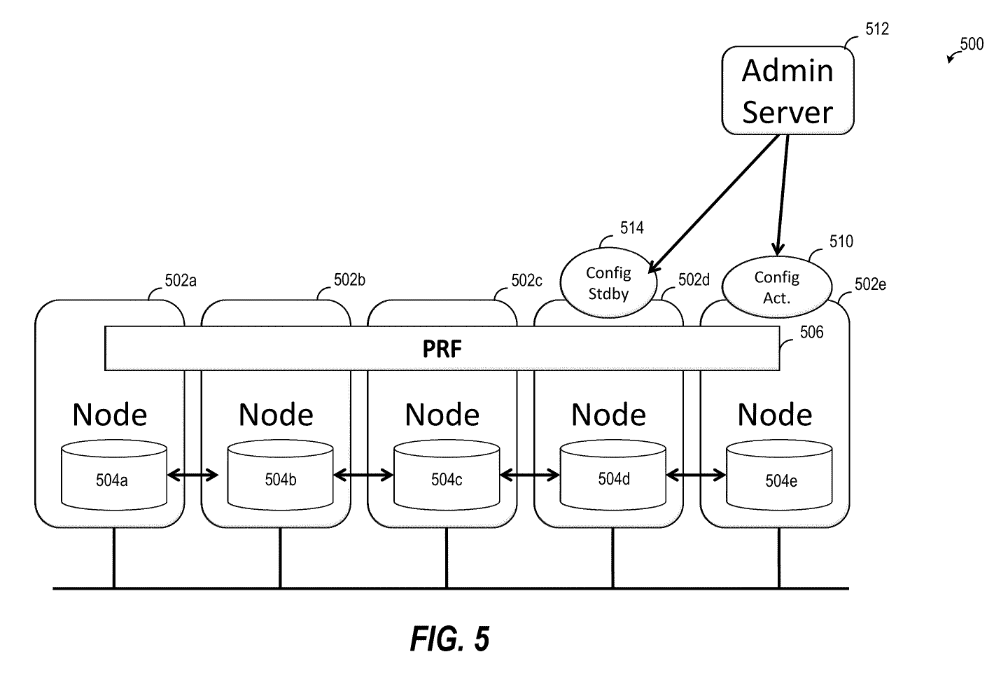

FIG. 5 shows a functional block diagram for another example cluster. The cluster 500 includes five nodes 502a, 502b, 502c, 502d, and 502e. Each node is shown as including a database server 504a, 504b, 504c, 504d, and 504e. The database servers may be coupled to allow data communication between each database server. As shown, neighboring servers are communicating, however, it will be understood that any give database server may be configured to communicate with one or more of the other database servers in the cluster 500. Nodes in the cluster are not required to know the number of nodes that make up the cluster at any given point in time.

The cluster 500 includes a policy routing function (PRF) 506. The policy routing function 506 controls the balancing of calls across the nodes 502 for the cluster 500. The policy routing function 506 may be implemented on a computing device including a processor. In some implementations, the policy routing function 506 may be distributed across the nodes 502. For example, each node in the cluster 500 may be configured to perform policy-based routing. In one implementation, a policy routing function processor included in each node is configured to provide the policy-based routing features. The policy routing function processor may utilize the distributed database to obtain the policy rules and cluster configuration information.

One node may be configured as the host for an active configuration processor 510. The active configuration processor 510 may be accessed by an administrator 512 to configure the cluster 500 as described. In some implementations, the administrator 512 may be configured to active a node as the active configuration processor 510 such as via a configuration message. A second node may be configured to host the standby configuration processor 514. The standby configuration processor 514 is configured to provide a back-up should the active configuration processor 510 experience an outage. The second node may be configured to host the standby configuration processor 514 via the administrator.

In an example deployment of a cluster architecture, a cluster of applications are created through the configuration processor. Nodes can be virtual machines or server hardware. Nodes are configured using a configuration management application executing on the configuration processor and are clustered together using a cluster ID.

A cluster can span across a single LAN, or across multiple networks using a WAN. This can provide geo-diverse clustering. A single server can support multiple clusters for different applications. A node can only be a member of a single cluster, meaning nodes cannot be members of multiple clusters for different applications. As shown in FIG. 5, each node is connected to each other node. In some implementations, the connection may include bridging a first local area network to a second local area network. In such implementations, the nodes may not be hosted on the same local area network, but be configured to communicate. Furthermore, intermediary elements such as security, monitoring, routing, etc. are not shown in FIG. 5, but may be included between one or more nodes to enhance the functionality of the described system.

Each node for a legacy network gateway (LNG) may contain one or more of the following servers/processes:
1. back to back user agent (B2BUA) server
2. collaborative and distributed emergency multimedia data management server (e.g., Amber Information Management system)
3. location information function (LIF)
4. statistics engine
5. database
6. availability management framework (AMF)
7. messaging queue(s)

Each node for the ESRP will contain one or more of the following servers/processes:
1. B2BUA server
2. AIM
3. LIF
4. policy and routing function (PRF)
5. statistics engine
6. database
7. availability management framework (AMF)
8. messaging queue(s)

Load Balancing

In some implementations, it may be desirable for the cluster to include load balancing. In such implementations, upstream devices can distribute calls to each node in the cluster. The load balancing can be done as round robin or volume based. The balancing can be applied based on the configuration of the upstream device. Each node receiving the call will be responsible to process that call. Each node will process calls independently and each node in the cluster will have the exact same capability for processing calls. Nodes within the cluster will share call state data with the cluster.

Upstream devices may be configured to maintain a heartbeat with the cluster nodes to ensure calls can be sent to each node. This can be done using a load balancing appliance, such as those commercially available from Cisco™, or the device can maintain a list of nodes and heartbeat each node, example using SIP options.

Nodes can hand off calls to other nodes in the cluster. Processing of the calls can be distributed across the cluster. For example, LIF processing can be performed in one node and PRF processing can be performed in another node based on process load balancing.

Distributed Database

The cluster architecture includes a distributed database. Cassandra DB is one example of a commercially available distributed database developed and distributed by the Apache Software Foundation. The distributed database is configured to allow sharing of data across the cluster. The distributed database, in some implementations, is configured to perform active synchronization across each database instance within the local cluster. This ensures that data is synchronized across the nodes in the cluster (within the LAN) once the data is written. Control is not handed back to the writing application until sync is achieved.

For database instances across a geo-diverse cluster, this synchronization operation is a lazy synchronization. A lazy synchronization generally refers to a synchronization operation performed in parallel, as time permits. Accordingly, geo-diverse clusters may not synchronize simultaneously, but they will, over time, synchronize.

Each session that is created by a node in the cluster will mark the owning node where the session was created. This is to ensure that the SIP processing for that session is handled by the originating node.

If any database instance fails on a node, the entire node may be removed from the cluster until the database is brought back up.

To ensure that we do not have a race condition for PRF, synchronization write operations to a session across the cluster may be performed. This can be achieved by each node writing session updates to the distributed database instance that owns that session.

PRF Clustering

Policy routing function (PRF) such as call distribution in a cluster architecture can be a complex process. Features may be included to ensure that policy execution and distribution is done fairly across nodes in the cluster. As an example, if the PRFs in a cluster were to perform the same call distribution function based on an algorithm, then multiple nodes continue to select the same distribution point each time as opposed to a fair distribution based on previous selection. Also, it is desirable in some implementations, for the PRFs in the cluster to distribute calls to downstream recipients. In such instances, the recipient pool may be virtually “connected” to each node in the cluster.

One aspect of PRF clustering is downstream registration. Each PRF is configured to maintain a list of downstream devices that can receive calls from queues (e.g., de-queue). This registration can be done through, for example, an HTTP queue registration request or login/authentication for an agent.

In some implementations, each PRF node in the cluster receives this list from the registration service and maintains a list of downstream devices per outbound queue. This list can be agent devices or ESRP devices. The downstream registration is maintained in the distributed database and each PRF reads this information from the distributed database as the distributed database is updated.

Downstream devices may be assigned to a single node for managing that device and distributing calls to that device. If a downstream device loses communication with the cluster node, the downstream device may be assigned to another node in the cluster. This assignment may be performed by the downstream device. For example, the downstream device may be configured to maintain a list of nodes it can register with. These nodes can be local to a cluster or across geo-diverse.

Another aspect of PRF clustering is queue state processing. PRF processes the state of the downstream recipients and well as notify upstream devices of its current queue state.

When a downstream device registers with cluster, an entry for the downstream device is added to the distributed database. PRF nodes in the cluster query this entry for the state of the downstream device.

The downstream device may be configured to update a SIP B2BUA node for state changes for that device. The B2BUA is configured to notify the PRF of the state change and the PRF will continue to update the entry for that device in the distributed database. Similarly, the cluster manages a queue state for its upstream devices. The cluster itself will have a local queue state for each type of queue configured for that cluster (e.g., 9-1-1, wireless, admin, etc.).

Once queues for the cluster are configured, a database entry may be created for that queue. This entry manages, in part, the total queue call count for the cluster. Each PRF node in the cluster queues calls sent to that node. The PRF updates the queue entry in the distributed database for calls that are added or removed for its queue. The queue entry in the distributed database will then represent the accumulated queue count of the PRF nodes in the cluster. The PRF node may be configured to check the total call count for that queue before deciding to queue the call for processing. If the call count exceeds the queue threshold, then a queue state notification may be sent to the upstream device that sent that call.

In some implementations, each PRF node in the cluster monitors this queue count such that if the queue count drops below the ready threshold, the PRF can then update the upstream devices of the ready state. This monitoring can occur with a regular frequency over time such as once per second or once per millisecond. An alternative approach is to configure the distributed database to send the notification to the PRF when the lower threshold it hot.

Yet another aspect of PRF clustering is PRF processing of new calls. Each PRF is configured to process calls from its set of inbound queues. As a PRF removes a call off its queue, the PRF decrements the queue call count in the distributed database. The PRF executes the originating policy for that call and then pulls the terminating policy from the distributed database. The PRF will then use the data stored with the terminating policy and call data to execute the terminating policy logic. Once the outcome of the policy is selected, the terminating policy is updated and returned to the database.

The system may allow for multiple PRF nodes to process calls against these terminating policies in parallel instead of putting a lock on the policy. This could result in staggered results, but is acceptable under high call volumes. This is mitigated by ensuring quick policy processing and inserting policy results back before continuing processing the call. Once a policy result is determined, the PRF queues the call in the outbound queue for downstream devices.

A further aspect of PRF clustering is PRF call distribution. The distribution logic of the PRF will determine how the call is de-queued from the queues. Each destination queue will be configured for the distribution mode (e.g., automated call distribution (ACD), priority, selective answer, etc.).

For ACD mode, PRFs may distribute the call automatically to the next available downstream device. In such a mode, a PRF may select the next device from the list of devices set against the queue in the distributed database. The PRF then sends the call to the downstream device. At this point, the PRF may identify the session as in progress in the distributed database. The PRF may also update the queue device list with the chosen device. This will ensure that any other PRF node in the cluster will not attempt to send a call in parallel to the same device.

Since database synchronization may take a few milliseconds to propagate updates to the nodes, there is a chance that multiple calls can be sent to the same device. This condition can be handled by the downstream device as either queuing these calls or rejecting all but one. The PRF may not de-queue the call from its destination queue until the call is accepted by the downstream device.

Another aspect of PRF clustering is manually de-queuing calls. Downstream devices can manually de-queue from the destination queues when the queue distribution mode is priority answer (PA) or selective answer (SA).

When a call is queued up in a destination queue with distribution type PA or SA, PRF sends a call queued notification to the downstream devices that are registered to de-queue from that queue. In this mode, downstream devices may request the PRF node that they are registered with. Although downstream devices will have visibility to the calls in each PRF destination queue, the actual session data is stored on the distributed database. This way a downstream device can request any call from any PRF through the registered PRF. The requested PRF sends a distribute call event to the owning PRF to send the call to the downstream device. This can eliminate the race condition where multiple requesters are asking to select the call. The owning PRF may be configured to send the call to the first requester and deny to the others.

PRF clustering may also include maintaining PRF statistics. When the system is configured with clusters and cluster queues, one or more management information bases (MIBs) are created to represent call statistics in the system. Each PRF may be configured to update these MIBs with call count and policy count statistics. These MIBs may be managed by the statistics engine, however the MIB values are stored in the distributed database.

The distributed database is responsible for maintaining the synchronization of incremental counts from the PRFs included in the cluster.

Each PRF may be configured to maintain one or more of the following MIBs per node:
Inbound calls queued
Inbound calls processed
Policy execution stats
Outbound queue call count per destination device
Calls failed
Threshold limits per PRF

A PRF may update the MIB and send a message to the stats engine to report to listeners.

Cluster MIBs can include:
Queue call counts and thresholds
Number of nodes provisioned
Number of nodes active
Number of downstream registered devices.

SIP High Availability in a Cluster

It may be desirable for the cluster to ensure active calls can be processed by any node in the cluster if the owning node goes down. For calls that are in progress, when a cluster node is lost, the system may clean up the calls in progress and re-establish the communication. Since the call state is managed in the distributed database, any node in the cluster will have access to the call session state and can continue to process call events related to that call.

AMF may be configured to detect which node failed and select a new node to take over control of those sessions. Sessions may be in one of two states: 1. Session in transition; or 2. Session in progress.

For sessions in transition, this means that the sessions are not anchored to the media server. The upstream device will detect loss of SIP packets and re-invite the session on a newly selected node using load balancing. The new node receiving these sessions will update the session data accordingly.

For sessions in progress, this could include established sessions and queued sessions which are anchored to the media server. When AMF selects a new node, the node will identify sessions that were orphaned and recreate the session state in the B2BUA. The B2BUA will use the previous state and transaction ID's from the distributed database (e.g., session information). The B2BUA is configured to transmit a message to update the downstream device. The message includes information for the downstream device to update the contact info for that SIP session. Subsequent call control is then managed by the new node.

The B2BUA will track the number of sessions migrated successfully and the number of sessions failed. For failed sessions, a real-time transport protocol (RTP) voice and media server anchoring may be maintained until the call is released by the caller. This may be detected by absence of media from caller.

Media Server High Availability

The media server (MS) may be included in some implementations to anchor calls at the terminating ESRP or at an ESRP that requires recording and/or interactive voice/media response (IMR/IVR).

The media server can be configured as a single active standby pair or multiple active and one standby (N+1).

Nodes in the cluster may use the same set of media servers for anchoring calls. If there are multiple active MS, then the system may load balance the sessions for the cluster. If one media server fails while a call is anchored, the AMF may detect the failure. The AMF may notify the conference applications on each node of the failed media server. The conference application selects, in some implementations, the standby media server and refers calls to that new MS. The session data is then updated with the new MS. The standby media server generally includes a similar capacity to the active MS. In some implementations, it may be desirable to have more than one active MS to fail over to a single stand by instance. In these implementations, the capacity included in the standby MS is provided based on the sum of the capacities of the MSs it will serve in the event of a failure.

Once the failed media server is restored, the sessions on the standby MS remain hosted on the standby MS until the session is torn down. Sessions may not fail back, however any new sessions will continue to be anchored on the originally active MS.

Nodes in the cluster may be configured to prefer the active media servers if any before anchoring sessions on the standby MS. The standby MS remains standby even after the active MS s have failed.

Private Branch Exchange (PBX) Redundancy

Clusters may include or communicate with a redundant PBX. The PBX includes its own high availability strategy. The cluster will need to maintain the active instance of the PBX.

AMF may update the cluster instance in the distributed database with the active PBX IP address. This could also be maintained by DNS name authority pointer (NAPTR) records.

Node Management

The system will maintain a node state for each node in the cluster. This state is used to determine the health of the node. AMF is used to manage the nodes in the cluster and report its state through a MIB.

Examples of node states include:
1. Provisioned
2. Active
3. Shutting Down
4. Offline
5. Failed

The failed state refers to a node having trouble accessing any of its components (e.g., DB, PRF, B2BUA, etc.).

One aspect of node management is adding a node to the cluster. Nodes can be added any time to the cluster. Once a node is added and activated, the node can start processing calls directed to it. The number of nodes that can be added to a cluster is limited by the physical characteristics of the network (e.g., power, memory, physical space). Before a node is added, AMF will prepare the node so it can become part of the cluster. Preparing the node involves synchronization of node characteristics. Once synchronized, the node transitions from provisioned to active.

Another aspect of node management is removing a node from a cluster. Two examples of ways that a node can be removed are: 1. Loss of a node (unplanned); and 2. Gracefully removed.

In the case of graceful removal, the node will stop receiving new calls and empty its current queues. Once the queues are empty, the node transitions to the offline state, where it can be removed. Gracefully removing a node will allow the sessions to be migrated to another node.

When a node is lost, the downstream devices may reestablish registration with another node. This may include re-authentication.

A further aspect of node management is handling orphaned sessions. A session becomes orphaned once the node that was managing the session is lost. When a node is lost, the AMF may select a new node to handle the orphaned sessions for re-established calls.

In general, there are two kinds of orphans: 1. In progress; and 2. Established.

In progress orphans are sessions without calls established. In progress orphans will time out against a node. This will cause the session to re-establish with another node, or disconnect and continue as abandoned call. In progress orphans will not be re-assigned to other nodes.

Established orphans are sessions who already have media streams established. This means that these sessions, to continue, will transition to become managed by another node. Once the new node has registered the new downstream device, the established sessions will be allocated to the new node.

Cluster Configuration

In one example, the configuration model administered by the configuration processor may contain a “cluster” component in the tree. In such an example, under each cluster component, the administrator can configure any number of clusters with a name.

Each cluster object may include one or more of the following attributes:
1. Cluster name
2. Node list (this is a list of machines by IP address)
3. Cluster queues
4. Future attributes
5. PBX instance

When a device (or tenant) is configured (e.g., associated with an ESRP), the device is assigned to a cluster. By assigning the device to a cluster, the system may identify which devices are part of a cluster.

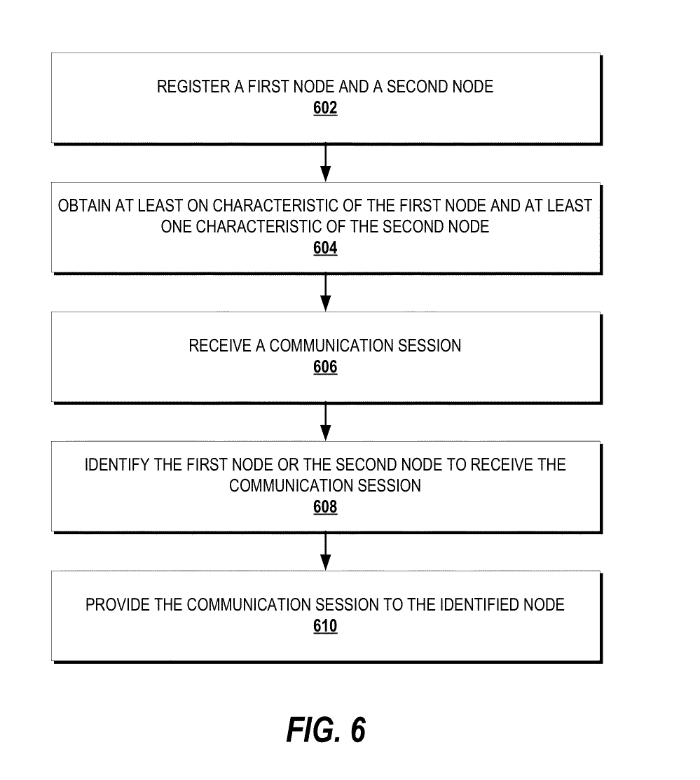

FIG. 6 shows a process flow diagram of an example method of managing communication sessions. The method shown in FIG. 6 may be implemented in whole or in part by one or more of the devices shown such as those in FIG. 2 or 3. In some implementations, the method may be implemented as non-transitory machine readable instructions executable by a processor of a device configured for managing communication sessions. At block 602, a first node and a second node are registered. The registration of the first node and the second node may be with the same cluster or with different clusters. The registration may be performed via messages transmitted from the node to a central management processor.

At block 604, at least one characteristic of the first node and at least one characteristic of the second node are obtained. The characteristic may be obtained through a request for information transmitted from a session router to the nodes. The characteristic may be obtained through a look-up for information for a node in a distributed database. The characteristic may be obtained via a message broadcasted from the nodes (e.g., status message).

At block 606, a communication session is received. At block 608, one of the first node or the second node is identified to receive the communication session. The identification is based at least in part on a policy and the at least one characteristic of the first node and the at least one characteristic of the second node.

At block 610, the communication session information is provided to the identified node. In some implementations, providing may include updating one or more values in the distributed database to indicate the communication session information is to be associated with the identified node. In some implementations, providing may include transmitting the communication session information to the identified node. It may be desirable to include acknowledgment messages in such implementations such that the session routing will be complete upon receipt of the acknowledgment message for a given communication session. If no acknowledgment is received (e.g., after a predetermined period of time), another node may be identified for the communication session.

Example Call Management Flow

A detailed implementation of the method shown in FIG. 6 is described in the flow listed below. The example describes a clustered terminating ESRP incorporating one or more of the features described above.
1. System is configured with a 5 node local cluster.
2. Cluster is configured with 3 queues (911, wireless, admin).
3. 200 agents are registered with the cluster, 40 agents per node.
4. A destination queue is created via configuration for each ACD group/skillset.
5. Each agent is configured to register with one active node and will failover to one other node if active node fails.
6. Agent registers with a node by logging into the node. Each agent has a preference and state.
7. AAA notifies PRF of the agent login and updates the distributed database with the destination queue to agent mapping.
8. Each PRF is notified of this mapping and adds to their distribution mapping.
9. New 911 call is load balanced to a B2BUA on a node in the cluster.
10. The B2BUA notifies PRF to distribute the call (assume, for this example, call distribution mode is ACD).
11. PRF will check the IN queue limit for the type of call (e.g., 9-1-1).
12. Assuming queue is available, PRF queues call locally and update the 9-1-1 queue count in the distributed database.
13. Second PRF thread de-queues the call from the inbound queue and decrements the queue call count.
14. PRF executes the originating policy and then selects the terminating policy from the distributed database based on the result of the originating policy.
15. After executing the terminating policy, the PRF updates the distributed database with the terminating policy results.
16. PRF queues the call on the destination queue that was selected as a result of the terminating policy.
17. PRF selects a device (agent) from the queue recipient list.
18. If the agent is registered with this node, then the PRF sends the call to the recipient.
19. If the agent is registered with another PRF node, the agent will update its state with its PRF.
20. If the agent does not answer the call in the configured amount of time, the PRF will select a new agent.
21. Once a call is acknowledged by the recipient, the agent list is updated in the distributed database.
22. If the node fails, the agent will login to its secondary node
23. The secondary node will resume control of the session.

Trouble Shooting

In some implementations, one or more nodes in a cluster may be configured to provide troubleshooting guidance. Examples of troubleshooting guidance include:
1. Showing the list of devices registered with each node
2. Showing the list of calls in each queue (in and out)
3. Showing the stats per node
4. Showing the cluster node membership
5. Showing the session node ownership
6. Showing the downstream device state
7. Showing the downstream registration table
8. Showing node membership state

Each node may be configured to trace a call through the node and show a log trail of the call processing.

Performance and Scalability

Adding nodes in a cluster can increase performance and scalability, but this is not a linear increase. Various factors can influence the overall cluster performance when adding nodes.

For example, once more data is collected via additional nodes, then a method to engineer call volumes may be established. The method may include determining the number of nodes for a cluster based at least in part on the quantity of data expected, characteristics of a node (e.g., processing power, speed, memory, network connectivity, bandwidth, physical location) and one or more latencies. One latency which may be considered is database synchronization latency. As nodes are added, a latency in write operation to the distributed database may occur. Another source of latency is downstream load balancing. For example, additional message hops may be introduced when sending calls to recipients when the number of downstream devices is not increased in conjunction with the nodes.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “providing” encompasses a wide variety of actions. For example, “providing” may include generating and transmitting a message including the information to be provided. “Providing” may include storing the information in a known location (e.g., database) for later consumption. “Providing” may include presenting the information via an interface such as a graphical user interface. In some implementations, “providing” may include transmitting the information to an intermediary prior to the intended recipient. It should be understood that “providing” may be to an end user device or to a machine-to-machine interface with no intended end user/viewer.

As used herein, a phrase referring to “at least one of” a list of items refers to any combination of those items, including single members. As an example, “at least one of: a, b, or c” is intended to cover: a, b, c, a-b, a-c, b-c, and a-b-c.

The word “exemplary” is used herein to mean “serving as an example, instance, or illustration.” Any aspect or embodiment described herein as “exemplary” is not necessarily to be construed as preferred or advantageous over other aspects or embodiments. Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different communication technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web-site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a device or component included therein as applicable. For example, such a device can be coupled to a server to facilitate the transfer of means for performing the methods described herein. Alternatively, various methods described herein can be provided via storage means (e.g., RAM, ROM, a physical storage medium such as a compact disc, or floppy disk, etc.), such that a device or component included therein can obtain the various methods upon coupling or providing the storage means to the device. Moreover, any other suitable technique for providing the methods and techniques described herein to a device can be utilized.

Headings are included herein for reference and to aid in locating various sections. These headings are not intended to limit the scope of the concepts described with respect thereto. Such concepts may have applicability throughout the entire specification.

It is to be understood that the claims are not limited to the precise configuration and components illustrated above. Various modifications, changes and variations may be made in the arrangement, operation and details of the methods and apparatus described above without departing from the scope of the disclosure.

While the foregoing is directed to aspects of the present disclosure, other and further aspects of the disclosure may be devised without departing from the basic scope thereof.

What is claimed is:

1. A system comprising:
a first node and a second node, the first node and the second node configured to receive and maintain communication session information, the first node and the second node executing on at least one session management server;
a distributed database, wherein the first node and the second node include an instance of the distributed database, the distributed database configured to store at least one characteristic of the first node and at least one characteristic of the second node;
a session load balancing server configured to:
receive a communication session;
identify one of the first node or the second node to receive the communication session based at least in part on a policy and the at least one characteristic for the first node and the at least one characteristic of the second node; and
produce an indicator indicative of the communication session and the identified node, wherein the identified node is configured to obtain the communication session from the distributed database.

2. The system of claim 1, wherein the communication session information includes a session state, a session identifier, and a current node.

3. The system of claim 1, wherein the characteristic of the first node and the second node includes one or more of a number of answering points coupled to the node, a number of communication sessions handled over a unit of time, a node load, or a node session volume.

4. The system of claim 1, further comprising a cluster management server configured to monitor the first node and the second node, and
wherein upon failure of one of the first node or the second node, the cluster management server is configured to update one or more communication session information entries in the distributed database associated with the failed node, the entries to be associated with an active node, the active node configured to reconstruct the communication session based at least in part on the communication session information.

5. The system of claim 4, wherein the update is based on at least in part on the policy and the at least one characteristic of the active node.

6. The system of claim 4, wherein the cluster management server is configured to:
generate a re-invite message based on the communication session information; and
transmit the re-invite message to the active node.

7. The system of claim 4, wherein the cluster management server is configured to:
receive a registration request from a third node, the registration request including a node configuration and a node state; and
store the registration request in the distributed database, wherein the session load balancer is configured to identify one of the first node, the second node, or the third node to receive the communication session.

8. The system of claim 1, wherein the communication session is a session initiation protocol communication session.

9. The system of claim 1, wherein the first node is associated with a first answering point and the second node is associated with a second answering point.

10. The system of claim 1, wherein the policy includes a threshold value for a node characteristic, and wherein a node is identified based on a comparison of a value for the characteristic of the node with the threshold value.

11. A method of managing communication sessions, the method comprising:
registering a first node and a second node;
obtaining at least one characteristic of the first node and at least one characteristic of the second node;
receiving a communication session;
identifying one of the first node or the second node to receive the communication session based at least in part on a policy and the at least one characteristic of the first node and the at least one characteristic of the second node; and
providing communication session information to the identified node.

12. The method of claim 11, wherein the communication session information includes a session state, a session identifier, and a current node.

13. The method of claim 11, wherein the characteristic of the first node and the second node includes one or more of a number of answering points coupled to the node, a number of communication sessions handled over a unit of time, a node load, or a node session volume.

14. The method of claim 11, further comprising:
upon failure of one of the first node or the second node, updating one or more communication session information entries in the distributed database associated with the failed node, the entries to be associated with an active node, the active node configured to reconstruct the communication session based at least in part on the communication session information.

15. The method of claim 14, wherein said updating is based on at least in part on the policy and the at least one characteristic of the active node.

16. The method of claim 14, further comprising:
generating a re-invite message based on the communication session information; and
transmitting the re-invite message to the active node.

17. The method of claim 14, further comprising:
receiving a registration request from a third node, the registration request including a node configuration and a node state; and
storing the registration request in the distributed database, wherein said identifying includes identifying one of the first node, the second node, or the third node to receive the communication session.

18. The method of claim 11, wherein the communication session is a session initiation protocol communication session.

19. The method of claim 11, wherein the first node is associated with a first answering point and the second node is associated with a second answering point.

20. A computer readable storage medium comprising instructions, said instructions, upon execution by a processor of a device, causing the device to:
register a first node and a second node;
obtain at least one characteristic of the first node and at least one characteristic of the second node;
receive a communication session;
identify one of the first node or the second node to receive the communication session based at least in part on a policy and the at least one characteristic for the first node and the at least one characteristic of the second node; and
provide communication session information to the identified node.

21. A system comprising:
means for receiving and maintaining communication session information;
means for distributed storage of at least one characteristic of the means for receiving and maintaining communication session information;
means for session load balancing configured to:
receive a communication session;
identify said means for receiving and maintaining communication session information to receive the communication session based at least in part on a policy and the at least one characteristic; and
produce an indicator indicative of the communication session and the identified means for receiving and maintaining communication session information, wherein the identified means for receiving and maintaining communication session information is configured to obtain the communication session from said means for distributed storage.
